(19) United States
(12) Patent Application Publication
(10) Pub. No.: US 2025/0038905 A1
(43) Pub. Date: Jan. 30, 2025

(54) ASSOCIATING DEMODULATION REFERENCE SIGNAL PORTS TO SOUNDING REFERENCE SIGNAL RESOURCE SETS FOR SPATIAL DIVISION MULTIPLEXING COMMUNICATIONS

(71) Applicant: QUALCOMM Incorporated, San Diego, CA (US)

(72) Inventors: Mostafa KHOSHNEVISAN, San Diego, CA (US); Yitao CHEN, San Marcos, CA (US); Fang YUAN, Beijing (CN); Wooseok NAM, San Diego, CA (US); Xiaoxia ZHANG, San Diego, CA (US); Jing SUN, San Diego, CA (US); Tao LUO, San Diego, CA (US); Peter GAAL, San Diego, CA (US)

(21) Appl. No.: 18/696,585

(22) PCT Filed: Nov. 17, 2021
(86) PCT No.: PCT/CN2021/131109

§ 371 Date: Mar. 28, 2024

(51) Int. Cl. H04L 5/00; H04B 7/0456

(52) U.S. Cl. CPC H04L 5/0048; H04B 7/0456

(57) ABSTRACT

Various aspects of the present disclosure generally relate to wireless communication. In some aspects, a user equipment (UE) may receive a spatial division multiplexing configuration associated with a physical uplink shared channel (PUSCH) having a first set of transmission layers corresponding to a first sounding reference signal (SRS) resource set and a second set of transmission layers corresponding to a second SRS resource set. The UE may transmit a PUSCH communication that includes the first and second sets of transmission layers based at least in part on a port mapping that indicates a first association between a first subset of demodulation reference signal (DMRS) ports of a set of DMRS ports and the first set of transmission layers, and a second association between a second subset of DMRS ports and the second set of transmission layers. Numerous other aspects are described.

### FIELD OF THE DISCLOSURE

Aspects of the present disclosure generally relate to wireless communication and to techniques and apparatuses for associating demodulation reference signal ports to sounding reference signal resource sets for spatial division multiplexing communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive a spatial division multiplexing configuration associated with a physical uplink shared channel (PUSCH) having a first set of transmission layers corresponding to a first sounding reference signal (SRS) resource set and a second set of transmission layers corresponding to a second SRS resource set, wherein the first set of transmission layers comprises a first number of transmission layers and the second set of transmission layers comprises a second number of transmission layers. The one or more processors may be configured to transmit a PUSCH communication that includes the first set of transmission layers and the second set of transmission layers based at least in part on a port mapping that indicates a first association between a first subset of demodulation reference signal (DMRS) ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Some aspects described herein relate to a base station for wireless communication. The base station may include a memory and one or more processors coupled to the memory. The one or more processors may be configured to transmit a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers. The one or more processors may be configured to receive a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Some aspects described herein relate to a method of wireless communication performed by a UE. The method may include receiving a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers. The method may include transmitting a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Some aspects described herein relate to a method of wireless communication performed by a base station. The method may include transmitting a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers. The method may include receiving a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Some aspects described herein relate to a non-transitory computer-readable medium that stores a set of instructions for wireless communication by a UE. The set of instructions, when executed by one or more processors of the UE, may cause the UE to receive a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers. The set of instructions, when executed by one or more processors of the UE, may cause the UE to transmit a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Some aspects described herein relate to a non-transitory computer-readable medium that stores a set of instructions for wireless communication by a base station. The set of instructions, when executed by one or more processors of the base station, may cause the base station to transmit a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers. The set of instructions, when executed by one or more processors of the base station, may cause the base station to receive a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Some aspects described herein relate to an apparatus for wireless communication. The apparatus may include means for receiving a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers. The apparatus may include means for transmitting a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Some aspects described herein relate to an apparatus for wireless communication. The apparatus may include means for transmitting a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers. The apparatus may include means for receiving a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sounding reference signal (SRS) resource sets, in accordance with the present disclosure.

FIG. 4 is a diagram illustrating an example associated with associating demodulation reference signal (DMRS) ports to SRS resource sets for spatial division multiplexing (SDM) communications, in accordance with the present disclosure.

FIGS. 5 and 6 are diagrams illustrating example processes associated with associating DMRS ports to SRS resource sets for SDM communications, in accordance with the present disclosure.

FIGS. 7 and 8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

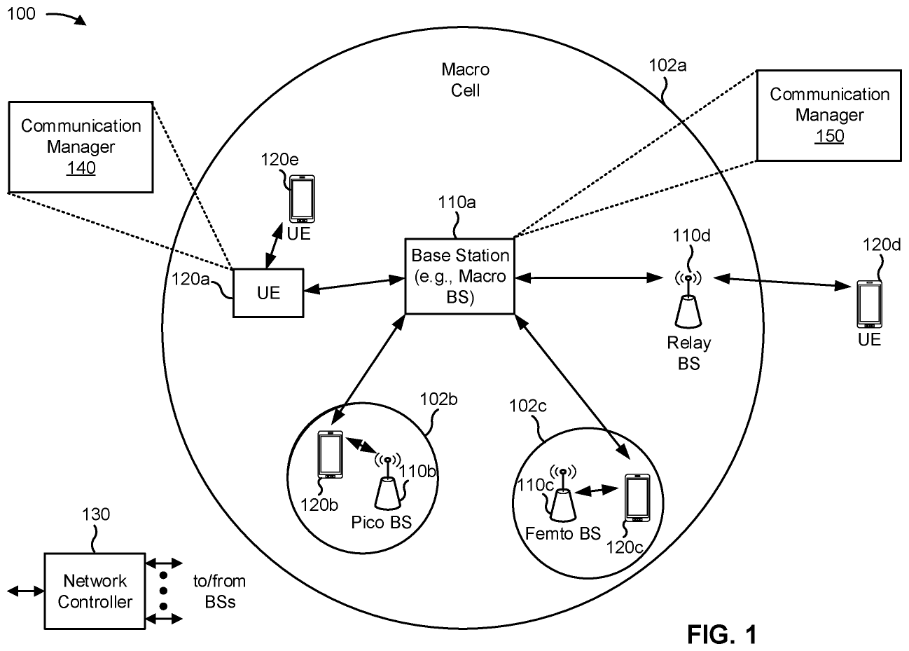

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a spatial division multiplexing configuration associated with a physical uplink shared channel (PUSCH) having a first set of transmission layers corresponding to a first sounding reference signal (SRS) resource set and a second set of transmission layers corresponding to a second SRS resource set, wherein the first set of transmission layers comprises a first number of transmission layers and the second set of transmission layers comprises a second number of transmission layers; and transmit a PUSCH communication that includes the first set of transmission layers and the second set of transmission layers based at least in part on a port mapping that indicates a first association between a first subset of demodulation reference signal (DMRS) ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers. Additionally, or alternatively, the communication manager 140 may perform one or more other operations described herein.

In some aspects, the base station 110 may include a communication manager 150. As described in more detail elsewhere herein, the communication manager 150 may transmit a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers; and receive a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers. Additionally, or alternatively, the communication manager 150 may perform one or more other operations described herein.

As indicated above, FIG. 1 is provided as an example. Other examples may differ from what is described with regard to FIG. 1.

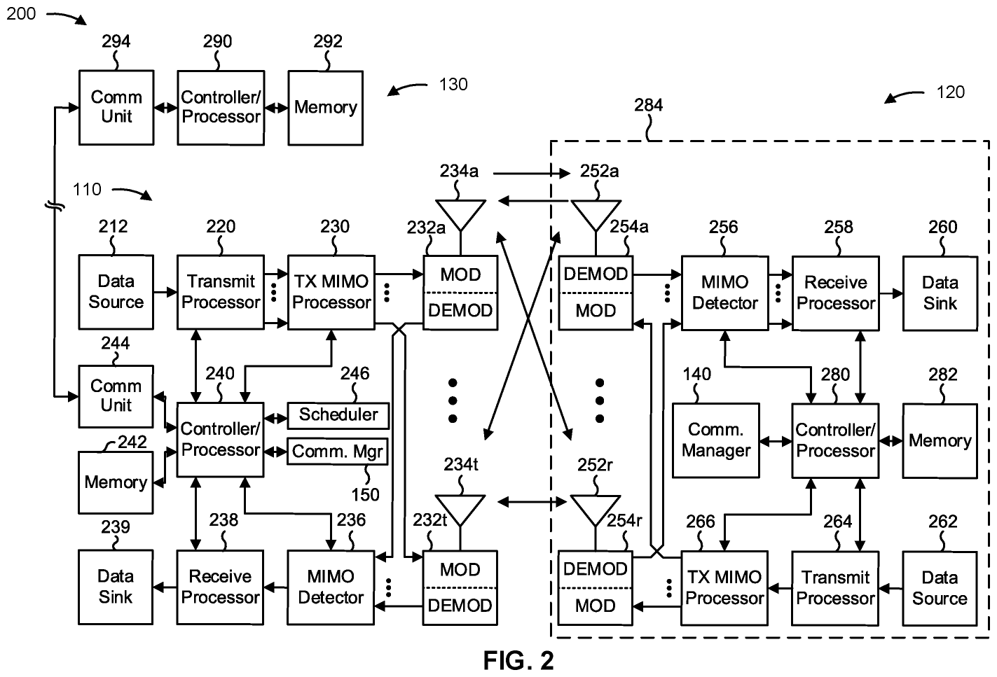

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-Statell)), a quasi-co-location (QCL) type (e.g., a qel-Type 1, qcl-Type2, qcl-TypeA, qcl-TypeB, qcl-Type (′, qcl-TypeD), and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

Some UEs and/or base stations may support full duplex operation in which the UEs and/or the base stations support full duplex operations. For example, a UE may support transmission via a first beam (e.g., using a first antenna panel) and may simultaneously support reception via a second beam (e.g., using a second antenna panel). Support for simultaneous transmission and reception may be conditional on beam separation, such as spatial separation (e.g., using different beams), frequency separation, and/or the like. Additionally, or alternatively, support for simultaneous transmission may be conditional on using beamforming (e.g., in frequency range 2 (FR2), in frequency range 4 (FR4), for millimeter wave signals, and/or the like).

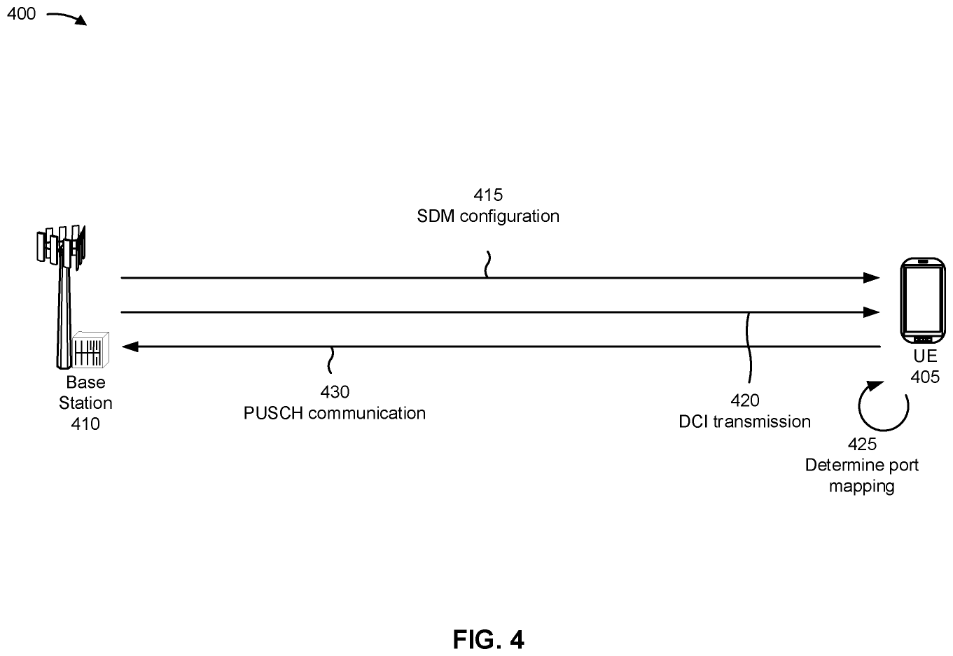

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

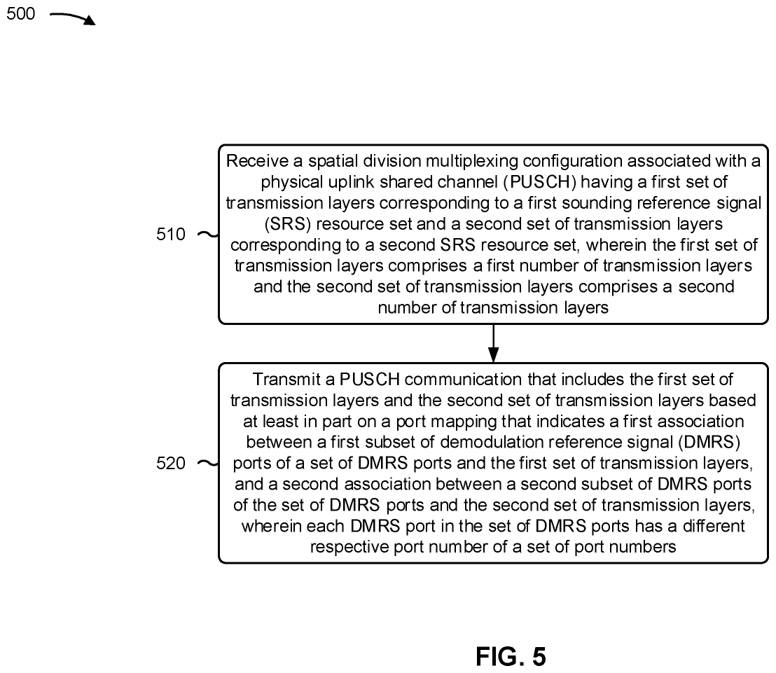

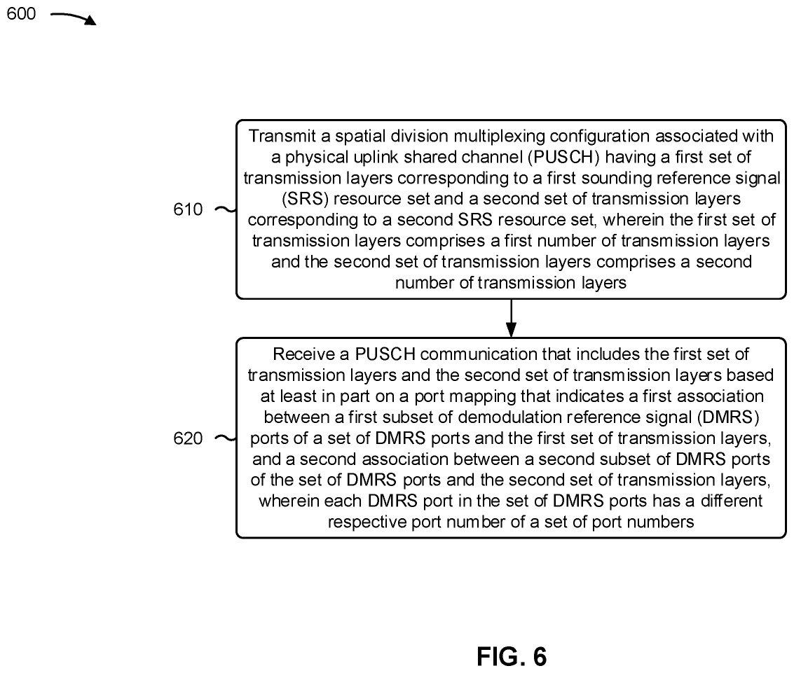

The controller/processor 240 of the base station 110, the controller/processor 280 of the UE 120, and/or any other component(s) of FIG. 2 may perform one or more techniques associated with associating DMRS ports to SRS resource sets for SDM communications, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE includes means for receiving a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers; and/or means for transmitting a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers; and/or means for receiving a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

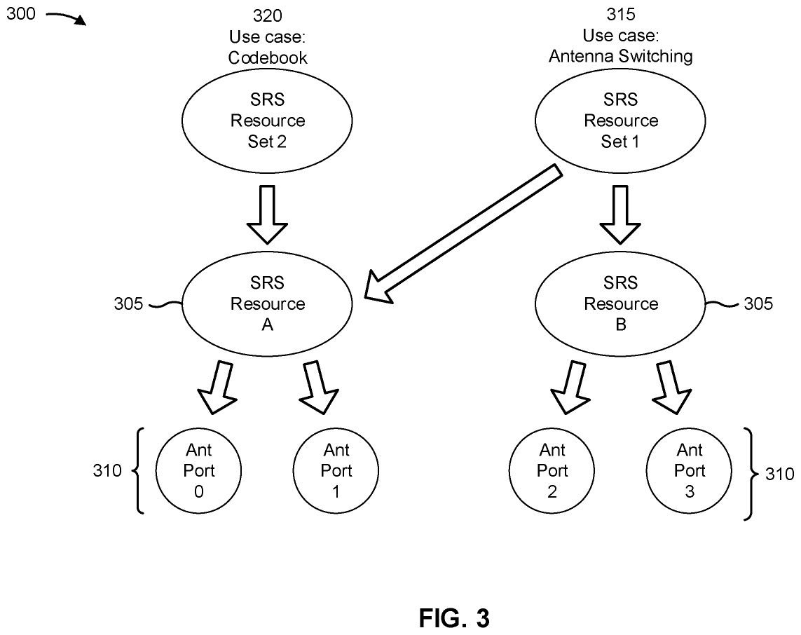

FIG. 3 is a diagram illustrating an example 300 of SRS resource sets, in accordance with the present disclosure.

A base station 110 may configure a UE 120 with one or more SRS resource sets to allocate resources for SRS transmissions by the UE 120. For example, a configuration for SRS resource sets may be indicated in a radio resource control (RRC) message (e.g., an RRC configuration message or an RRC reconfiguration message). As shown by reference number 305, an SRS resource set may include one or more resources (e.g., shown as SRS resources), which may include time resources and/or frequency resources (e.g., a slot, a symbol, a resource block, and/or a periodicity for the time resources). An SRS resource indicator (SRI) field in a downlink control information (DCI) transmission may be used to indicate SRS resources to be used for an uplink transmission. The SRI may indicate the uplink transmission rank and the set of precoders for the UE to use for the uplink transmission.

As shown by reference number 310, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a base station 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a base station 110 indicates an uplink precoder to the UE 120. For example, when the base station 110 is configured to indicate an uplink precoder to the UE 120 (e.g., using a precoder codebook), the base station 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the base station 110). In some aspects, virtual ports (e.g., a combination of two or more antenna ports) with a maximum transmit power may be supported at least for a codebook SRS.

A codebook SRS resource set also may be used to facilitate codebook-based physical uplink shared channel (PUSCH) transmission. In codebook-based PUSCH transmission, a UE can be configured with only one SRS resource set with a “usage” indicator set to “codebook.” In codebook-based PUSCH transmission, a maximum of 4 SRS resources within the set can be configured for the UE. Each SRS resource can be RRC-configured with a number of ports (e.g., using a parameter nrofSRS-Ports). The SRI field in the DCI that schedules the PUSCH can indicate one SRS resource. The number of ports configured for the indicated SRS resource determines the number of antenna ports used for the PUSCH transmission. In codebook-based PUSCH transmission, the PUSCH transmission is transmitted with the same spatial domain filter (e.g., uplink beam) as the indicated SRS resources. The number of transmission layers (rank) and the transmitted precoding matrix indicator (TPMI) for the scheduled PUSCH is determined from a separate DCI field.

A non-codebook SRS resource set may be used to indicate uplink CSI when the UE 120 selects an uplink precoder (e.g., instead of the base station 110 indicated an uplink precoder to be used by the UE 120. For example, when the UE 120 is configured to select an uplink precoder, the base station 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the base station 110).

A non-codebook SRS resource set also may be used to facilitate non-codebook-based PUSCH transmission. In non-codebook-based PUSCH transmission, a UE can be configured with only one SRS resource set with the “usage” indicator set to “noncodebook.” In non-codebook PUSCH transmission, a maximum of 4 SRS resources within the set can be configured for the UE. Each SRS resource has one port. The SRI field in the DCI that schedules the PUSCH transmission can indicate one or multiple SRS resources. The number of indicated SRS resources determines the rank for the scheduled PUSCH transmission and the PUSCH transmission is transmitted with the same precoder as well as the same spatial domain filter (e.g., beam) as the indicated SRS resources.

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI) or a MAC-CE.

In some aspects, the UE 120 may be configured with a mapping between SRS ports (e.g., antenna ports) and corresponding SRS resources. The UE 120 may transmit an SRS on a particular SRS resource using an SRS port indicated in the configuration. In some aspects, an SRS resource may span N adjacent symbols within a slot (e.g., where N equals 1, 2, or 4). The UE 120 may be configured with X SRS ports (e.g., where X≤4). In some aspects, each of the X SRS ports may mapped to a corresponding symbol of the SRS resource and used for transmission of an SRS in that symbol.

As shown in FIG. 3, in some aspects, different SRS resource sets indicated to the UE 120 (e.g., having different use cases) may overlap (e.g., in time and/or in frequency, such as in the same slot). For example, as shown by reference number 315, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 320, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

As indicated above, FIG. 3 is provided as an example. Other examples may differ from what is described with regard to FIG. 3.

In some wireless communication standards, PUSCH transmissions may be configured as PUSCH repetitions. In some cases, for example, PUSCH repetitions can be used to transmit one or more demodulation reference signals (DMRSs) to a base station. A DMRS may include a reference signal that is generated from a base sequence, such as a Zadoff-Chu sequence or a Gold sequence. A DMRS may carry information used to estimate a radio channel for demodulation of an associated physical channel. The physical channel may include, for example, a physical downlink control channel (PDCCH), a physical downlink shared channel (PDSCH), a physical uplink control channel (PUCCH), and/or a PUSCH, among other examples. The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. DMRSs are used for both downlink communications and uplink communications.

DMRSs can be transmitted using code division multiplexing (CDM). DMRS CDM grouping depends on a DMRS configuration type (DMRS Config Type) and a number of symbols. For example, for DMRS Config Type 1, there can be two CDM groups. For 1-Symbol DMRS, there are 4 ports having port numbers {0-3}. A first CDM group, CDM group 0, includes DMRS ports {0, 1} and a second CDM group, CDM group 1, includes DMRS ports {2,3}. For 2-Symbol DMRS, there are 8 ports having port numbers {0-7}. The first CDM group, CDM group 0, includes DMRS ports {0,1,4,5} and the second CDM group, CDM group 1, includes DMRS ports {2,3,6,7}. DMRS ports that belong to the same CDM group are orthogonal in the code domain (e.g., they are CDMed). Compared to DMRS ports in different CDM groups, the orthogonality property between DMRS ports in the same CDM group becomes weaker if the transmission parameters are not the same (e.g., when they are from different beams of the same UE or when they are from different UEs). Thus, it may be preferred that DMRS ports transmitted with different transmission parameters belong to different CDM groups when possible.

PUSCH repetitions can be transmitted using time division multiplexing (TDM), in which the PUSCH repetitions correspond to different transmission parameters (beam/spatial relation, power control, precoding). In some cases, PUSCH repetitions that are scheduled by a single DCI transmission can belong to two sets, where each set has its own transmission parameters. For example, in some cases, a UE may communicate with two TRPs. Communication with more than one TRP may be referred to as multiple-TRP (mTRP) communication, whereas communication with one TRP may be referred to as single-TRP (sTRP) communication. In mTRP, the two sets of PUSCH repetitions can correspond to two SRS resource sets. For example, a DCI transmission can indicate two beams and two sets of power control parameters using two corresponding SRI fields. For codebook-based PUSCH, the DCI transmission also indicates two TPMIs.

In some cases, a UE may be configured to dynamically switch between sTRP communication and mTRP communication. For dynamic switching between sTRP and mTRP (e.g., dynamic switching between one set of transmission parameters for PUSCH repetitions and two sets of transmission parameters for PUSCH repetitions), a wireless communication standard introduced a new field in the DCI format. The new field, which may be referred to as a dynamic switching field, is 2 bits and indicates that the UE is to use the first set of parameters only (e.g., to transmit to a first TRP, TRP1); use the second set of parameters only (e.g., to transmit to a second TRP, TRP2); use both sets of parameters for two sets of repetitions with a first order (TRP1, TRP2); or use both sets of parameters for two sets of repetitions with a second order (TRP2, TRP1), which may be referred to as a reversed order. In the case of TDM communications, the rank and DMRS ports can be the same across all the repetitions.

According to some wireless communication standards, an antenna ports field in an uplink-scheduling DCI (or in a configured grant (CG) configuration for Type 1 CG) indicates the DMRS ports. A number of transmission layers (e.g., which may be equal to a number of DMRS ports) is determined from other fields for the case of PUSCH. For example, for codebook-based PUSCH transmission, the number of transmission layers can be based on a “precoding information and number of layers” field. For non-codebook PUSCH transmission, the number of transmission layers can be based on the SRI field. For example, for non-codebook PUSCH transmission, the number of transmission layers can be equal to the number of SRS resources in the SRS resource set. Once the UE determines the rank (e.g., number of transmission layers), and also determines DMRS configuration (e.g., via the parameters dmrs-Type and maxLength) based on RRC configuration, the corresponding specified antenna port table is determined, and the antenna port field in the DCI points to one row from that table. DMRS ports and other information can be determined based on the antenna table.

In the case of SDM for PUSCH, different sets of layers have different transmission parameters (e.g., different beams, different sets of power control parameters, and/or different TPMIs, among other examples). The first set of transmission layers and/or DMRS ports can be associated with the first SRS resource set, and the second set of transmission layers and/or DMRS ports can be associated with the second SRS resource set. In some cases, a number of rank combinations can be supported such as, for example, rank combinations 1+1, 1+2, 2+1, 2+2, 1+3, and/or 3+1, among other examples.

However, wireless communication standards do not specify a technique for determining which DMRS ports belong to the first set of transmission layers (corresponding to the first SRS resource set) and which DMRS ports belong to the second set of transmission layers (corresponding to the second SRS resource set). In some cases, for example, when indicated DMRS ports belong to one CDM group (e.g., {0,1,4,5} for DMRS Config Type 1), the DMRS ports can be mapped to the two sets in any manner, but without a specified rule, a UE's mapping may be unanticipated by a base station, resulting in missed communications and network inefficiencies. Additionally, for example, when the indicated DMRS ports belong to two CDM groups (e.g., DMRS ports {0,2,4,6} for DMRS Config Type 1, and for 2+2 SDM PUSCH), it may be better to map DMRS ports {0,4} to the first set and DMRS ports {2,6} to the second set instead of mapping {0,2} to the first set and {4,6} to the second set as mentioned above, since DMRS ports and/or transmission layers in the first and second sets are transmitted with different transmission parameters. However, without a specification of the mapping, the UE may map {0,2} to the first set and {4,6} to the second set, which may result in interference, leading to missed communications and/or network inefficiencies.

Some aspects of the techniques and apparatuses described herein may facilitate associating DMRS ports to SRS resource sets for SDM. For example, in some aspects, a UE may receive an SDM configuration associated with a PUSCH having a first set of transmission layers corresponding to a first SRS resource set and a second set of transmission layers corresponding to a second SRS resource set. The first set of transmission layers may include a first number of transmission layers and the second set of transmission layers may include a second number of transmission layers. The UE may transmit a PUSCH communication having the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers. In this way, some aspects of the techniques described herein may facilitate mapping DMRS antenna ports to SRS resource sets for SDM PUSCH communications, thereby improving efficiencies and, in this way, positively impacting network performance.

FIG. 4 is a diagram illustrating an example 400 associated with associating DMRS ports to SRS resource sets for SDM PUSCH communications, in accordance with the present disclosure. As shown in FIG. 4, a UE 405 and a base station 410 may communicate with one another. For example, the UE 405 may be, or be similar to, the UE 120 depicted in FIGS. 1 and 2. The base station 410 may be, or be similar to, the base station 110 depicted in FIGS. 1 and 2.

As shown by reference number 415, the base station 410 may transmit, and the UE 405 may receive, an SDM configuration. The SDM configuration may be associated with a PUSCH having a first set of transmission layers corresponding to a first SRS resource set and a second set of transmission layers corresponding to a second SRS resource set. The first set of transmission layers may include a first number of transmission layers, r1, and the second set of transmission layers may include a second number of transmission layers, r2.

As shown by reference number 420, the base station 410 may transmit, and the UE 405 may receive, a downlink control information (DCI) transmission. The DCI transmission may include a first SRI field that indicates the SRS resources in the first SRS resource set and/or indicates a first number of SRS resources in the first set of SRS resources. The DCI transmission may include a second SRI field that indicates the SRS resources in the second SRS resource set and/or indicates a second number of SRS resources in the second SRS resource set. In some aspects, the DCI transmission may include a first transmitted precoder matrix indicator (TPMI) field that indicates the first number of transmission layers r1 and a second TPMI field that indicates the second number of transmission layers r2. In some aspects, the DCI transmission may include a dynamic switching field that indicates no reversed order or reversed order. In some aspects, the DCI may not include a dynamic switching field.

As shown by reference number 425, the UE 405 may determine a port mapping. In some aspects, the port mapping may indicate a first association between a first subset of DMRS ports of a set of DMRS ports and the first set of transmission layers. The port mapping may indicate a second association between a second subset of DMRS ports of the set of DMRS ports and the second set of transmission layers. In some aspects, each DMRS port in the set of DMRS ports has a different respective port number of a set of port numbers. For example, the set of DMRS port numbers may include the set of port numbers {0, 1, 2, 3, 4, . . . } or a portion thereof. The first subset of DMRS ports may include a first number of DMRS ports and the second subset of DMRS ports may include a second number of DMRS ports. In some aspects, the first number of DMRS ports may be equal to the second number of DMRS ports. In some aspects, the first number of DMRS ports may be not equal to the second number of DMRS ports.

In some aspects, to determine the port mapping, the UE 405 may determine the number of transmission layers in the first set of transmission layers (associated with the first SRS resource set) r1, and the number of transmission layers in the second set of transmission layers (associated with the second SRS resource set) r2. In some aspects, for non-codebook-based PUSCH transmission, r1 and r2 may be determined based at least in part on an indicated number of SRS resources in the first SRS resource set and the number of SRS resources in the second SRS resource set, respectively. As indicated above, the number of SRS resources in the first SRS resource set may be indicated by a first SRI field in the DCI transmission and the number of resources in the second SRS resource set may be indicated by a second SRI field in the DCI transmission.

For codebook-based PUSCH transmission, the UE 405 may determine the first number of DMRS ports based at least in part on a first number of transmission layers associated with a first TPMI and the second number of DMRS ports based at least in part on a second number of transmission layers associated with a second TPMI. For example, in some aspects, r1 and r2 may be equal to the number of layers associated with the first and second TPMIs (indicated by the two TPMI fields in the DCI transmission), respectively.

In some aspects, the UE 405 may determine the set of DMRS ports based on an antenna ports field in the DCI transmission, or a radio resource control (RRC) message that carries the SDM configuration, and an antenna port table, specified by a wireless communication standard, associated with rank=r1+r2. Accordingly, the set of DMRS ports may include a total number of DMRS ports equal to r1+r2 ports. The UE 405 may further determine the port mapping by determining a mapping between the set of r1+r2 DMRS ports to the first set of transmission layers and the second set of transmission layers.

In some aspects, the UE 405 may determine the mapping based at least in part on a sequential mapping operation. In some aspects, the sequential mapping operation may be applied when the DCI transmission does not include a dynamic switching field or when the DCI transmission includes a dynamic switching field that indicates no reversed order. For example, the first subset of DMRS ports may include a first number of DMRS ports, corresponding to a first subset of respective port numbers of the set of port numbers, equal to the first number of transmission layers r1. The second subset of DMRS ports may include a second number of DMRS ports, corresponding to a second subset of respective port numbers of the set of port numbers, equal to the second number of transmission layers r2, where a largest respective port number of the first subset of respective port numbers is smaller than a smallest respective port number of the second subset of respective port numbers. For example, in some aspects, the first r1 DMRS ports (with smaller port numbers) may be mapped to the first set of transmission layers and the remaining r2 DMRS ports (with larger port numbers) may be mapped to the second set of transmission layers.

In some aspects, if the dynamic switching field is included in the DCI transmission and indicates reversed order, a reversed mapping may be applied. For example, the second subset of DMRS ports may include a first number of DMRS ports corresponding to a first subset of respective port numbers of the set of port numbers equal to the second number of transmission layers r2. The first subset of DMRS ports may include a second number of DMRS ports corresponding to a second subset of respective port numbers of the set of port numbers equal to the first number of transmission layers r1, where a largest respective port number of the second subset of respective port numbers is smaller than a smallest respective port number of the first subset of respective port numbers. For example, in a reversed mapping the first r2 DMRS ports (with smaller port number) may be mapped to the second set of transmission layers, and the remaining r1 DMRS ports (with larger port numbers) may be mapped to the first set of transmission layers.

For example, the UE 405 may determine that r1=2 and r2=2. If the set of DMRS ports={0,2,4,6} and are of a first configuration type (DMRS Config Type 1), and if the DCI transmission indicates codepoint 10 (no reversed order), the port mapping may map DMRS ports {0,2} to the first set of transmission layers and DMRS ports {4,6} to the second set of transmission layers. If the DCI transmission indicates codepoint 11 (reversed order), the port mapping may map DMRS ports {0,2} to the second set of transmission layers and DMRS ports {4,6} to the first set of transmission layers. In another example, if r1=1, r2=2, the set of DMRS ports={0,1,2}, and the DCI transmission indicates codepoint 0, the port mapping may map DMRS port {0} to the first set of transmission layers and DMRS ports {1,2} to the second set of transmission layers. In this example, if the DCI transmission indicates codepoint 11, the port mapping may map DMRS ports {0, 1} to the second set of transmission layers and DMRS port {2} to the first set of transmission layers.

In some aspects, the port mapping may be based at least in part on a number of CDM groups of the set of DMRS ports. For example, in some aspects, if all of the DMRS ports of the set of r1+r2 DMRS ports belong to the same CDM group, and if the DCI transmission indicates no reversed order (or does not include a dynamic switching field), the port mapping may be the sequential port mapping described above. If all of the DMRS ports of the set of r1+r2 DMRS ports belong to the same CDM group, and if the DCI transmission indicates reversed order, the port mapping may be the reverse mapping described above. In some aspects, the case in which all of the DMRS ports of the set of r1+r2 DMRS ports belong to the same CDM group may be an error case. For example, where each DMRS port of the set of DMRS ports corresponds to a single CDM group, r1=2, r2=2, the set of DMRS ports={0,1,4,5}, the DCI transmission indicates codepoint 10, and the DMRS ports are of DMRS Config Type 1, the port mapping may map DMRS ports {0,1} to the first set of transmission layers and DMRS ports {4,5} to the second set of transmission layers. In this example, if the DCI transmission indicates codepoint 11, the port mapping may map DMRS ports {0,1} to the second set of transmission layers and DMRS ports {4,5} to the first set of transmission layers.

In some aspects, the set of r1+r2 DMRS ports may belong to two different CDM groups. If a first CDM group has r1 ports and the second CDM group has r2 ports, the r1 ports that belong to the first CDM group may be mapped to the first set of transmission layers, and the r2 ports that belong to the second CDM group may be mapped to the second set of transmission layers. If r1=r2, there may be two different possibilities for mapping the DMRS ports. For example, if the DCI transmission does not include the dynamic switching field, or if the DCI transmission includes the dynamic switching field and indicates codepoint 10 (no reversed order), r1 DMRS ports in the CDM group having a lower CDM group number of the two CDM group numbers corresponding to the first and second CDM group may be mapped to the first set of transmission layers, and r2 DMRS ports in the CDM group with the higher CDM group number may be mapped to the second set of transmission layers. If the DCI transmission includes the dynamic switching field and indicates codepoint 11 (reversed order), r1 DMRS ports in the CDM group with the higher CDM group number may be mapped to the first set, and r2 DMRS ports in the CDM group with the lower CDM group number may be mapped to the second set.

For example, if r1=2, r2=2, the set of DMRS ports={0,2,4,6}, the DCI transmission indicates codepoint 10, and the configuration type is DMRS Config Type 1, DMRS ports {0,4} may belong to CDM group 0 and DMRS ports {2,6} may belong to CDM group 1, and the port mapping may map DMRS ports {0,4} to the first set of transmission layers and DMRS ports {2,6} to the second set of transmission layers. In this example, if the DCI transmission indicates codepoint 11, the port mapping may map DMRS ports {0,4} to the second set of transmission layers and DMRS ports {2,6} to the first set of transmission layers.

In a situation in which DMRS ports belong to two CDM groups such that one CDM group has r1 ports and the other CDM group has r2 ports, and if r1 is not equal to r2, then dynamic switching with reversed order (codepoint 11) may not result in DMRS ports in the same CDM group to be mapped to the same set of transmission layers. In some aspects, this case may be configured as an error case. For example, in some aspects, the UE 405 may determine an error based at least in part on the first subset of DMRS ports corresponding to a first CDM group and the second subset of DMRS ports corresponding to a second CDM group, where the first subset of DMRS ports includes a first number of DMRS ports corresponding to a first subset of respective port numbers of the set of port numbers and where the second subset of DMRS ports includes a second number of DMRS ports corresponding to a second subset of respective port numbers of the set of port numbers. Determining the error may include determining that the first number of transmission layers is not equal to the second number of transmission layers.

In some aspects, the case in which DMRS ports belong to two CDM groups such that one CDM group has r1 ports and the other CDM group has r2 ports, and where r1 is not equal to r2, when the dynamic switching field indicates reversed order (codepoint 11), the first r1 DMRS ports (with smaller port number) may be mapped to the first set of transmission layers and the remaining r2 DMRS ports (with larger port numbers) may be mapped to the second set of transmission layers (e.g., a sequential mapping). In some aspects, where the dynamic switching field indicates reversed order (codepoint 11), the first r2 DMRS ports (with smaller port number) may be mapped to the second set of transmission layers and the remaining r1 DMRS ports (with larger port numbers) may be mapped to the first set of transmission layers (e.g., a reversed order mapping).

For example, if r1=1, r2=2, the set of DMRS ports={0,1,2}, DMRS ports {0,1} belong to CDM group 0, DMRS port {2} belongs to CDM group 1, and the DCI transmission does not include a dynamic switching field indicating reversed order, the port mapping may map DMRS port {2} to the first set and DMRS ports {0,1} to the second set. In this example, where the DCI transmission includes a dynamic switching field that indicates codepoint 11, the port mapping may map DMRS port {0} to the first set of transmission layers and DMRS ports {1,2} to the second set of transmission layers. If the r1+r2 DMRS ports belong to two different CDM groups but the condition that one CDM group has r1 ports and the other CDM group has r2 ports is not satisfied, the port mapping may include a sequential mapping or a reversed order mapping. In some aspects, this case may be configured as an error case. For example, in some aspects, if r1=3, r2=1, the set of DMRS ports={0, 1,2,3}, DMRS ports {0,1} belong to CDM group 0, DMRS ports {2,3} belong to CDM group 1, and the DCI transmission does not indicate reversed order, the port mapping may map DMRS ports {0,1,2} to the first set of transmission layers and DMRS port {3} to the second set of transmission layers. In this example, but where the DCI transmission indicates reversed order, the port mapping may map DMRS port {0} to the second set of transmission layers and DMRS ports {1,2,3} to the first set of transmission layers.

As shown by reference number 430, the UE 405 may transmit, and the base station 410 may receive, a PUSCH communication that includes the first set of transmission layers and the second set of transmission layers. In some aspects, the UE 405 may transmit the PUSCH communication based at least in part on a port mapping that indicates a first association between a first subset of DMRS ports of a set of DMRS ports and the first set of transmission layers, and a second association between a second subset of DMRS ports of the set of DMRS ports and the second set of transmission layers, as described above.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 405) performs operations associated with associating DMRS ports to SRS resource sets for SDM communications.

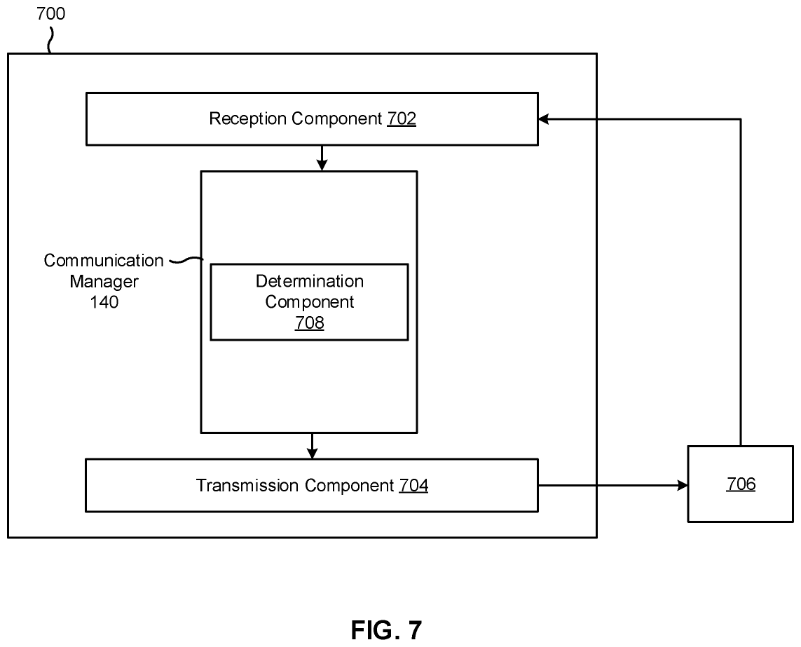

As shown in FIG. 5, in some aspects, process 500 may include receiving a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers (block 510). For example, the UE (e.g., using communication manager 140 and/or reception component 702, depicted in FIG. 7) may receive a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers, as described above.

As further shown in FIG. 5, in some aspects, process 500 may include transmitting a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers (block 520). For example, the UE (e.g., using communication manager 140 and/or transmission component 704, depicted in FIG. 7) may transmit a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers, as described above.

Process 500 may include additional aspects, such as any single aspect or any combination of aspects described below and/or in connection with one or more other processes described elsewhere herein.

In a first aspect, the first subset of DMRS ports comprises a first number of DMRS ports and the second subset of DMRS ports comprises a second number of DMRS ports.

In a second aspect, alone or in combination with the first aspect, transmitting the PUSCH communication comprises transmitting the first set of transmission layers and the second set of transmission layers using non-codebook-based transmission, wherein the first number of DMRS ports is based at least in part on a first number of SRS resources in the first SRS resource set, and wherein the second number of DMRS ports is based at least in part on a second number of SRS resources in the second SRS resource set.

In a third aspect, alone or in combination with the second aspect, process 500 includes receiving a DCI transmission comprising a first SRI field that indicates the first number of SRS resources and a second SRI field that indicates the second number of SRS resources.

In a fourth aspect, alone or in combination with one or more of the first through third aspects, transmitting the PUSCH communication comprises transmitting the first set of transmission layers and the second set of transmission layers using codebook-based transmission, wherein the first number of DMRS ports is based at least in part on a first number of transmission layers associated with a first TPMI, and wherein the second number of DMRS ports is based at least in part on a second number of transmission layers associated with a second TPMI.

In a fifth aspect, alone or in combination with the fourth aspect, process 500 includes receiving a downlink control information transmission comprising a first TPMI field that indicates the first number of transmission layers and a second TPMI field that indicates the second number of transmission layers.

In a sixth aspect, alone or in combination with one or more of the first through fifth aspects, the first subset of DMRS ports includes a first number of DMRS ports, corresponding to a first subset of respective port numbers of the set of port numbers, equal to the first number of transmission layers, and the second subset of DMRS ports includes a second number of DMRS ports, corresponding to a second subset of respective port numbers of the set of port numbers, equal to the second number of transmission layers, wherein a largest respective port number of the first subset of respective port numbers is smaller than a smallest respective port number of the second subset of respective port numbers.

In a seventh aspect, alone or in combination with the sixth aspect, process 500 includes receiving a DCI transmission, wherein the DCI transmission does not include a dynamic switching field.

In an eighth aspect, alone or in combination with the sixth aspect, process 500 includes receiving a DCI transmission, wherein the DCI transmission indicates no reversed order.

In a ninth aspect, alone or in combination with one or more of the sixth through eighth aspects, each DMRS port of the set of DMRS ports corresponds to a single code division multiplexing group.

In a tenth aspect, alone or in combination with one or more of the sixth through ninth aspects, the first subset of DMRS ports corresponds to a first CDM group and the second subset of DMRS ports corresponds to a second CDM group.

In an eleventh aspect, alone or in combination with one or more of the sixth through tenth aspects, the first number of transmission layers equals the second number of transmission layers.

In a twelfth aspect, alone or in combination with the sixth aspect, the first subset of DMRS ports corresponds to a first CDM group and the second subset of DMRS ports corresponds to a second CDM group, and the first number of transmission layers is different than the second number of transmission layers, and process 500 further includes receiving a DCI transmission, wherein the DCI transmission includes a dynamic switching field that indicates a reversed order.

In a thirteenth aspect, alone or in combination with one or more of the first through fifth aspects, the first subset of DMRS ports corresponds to a first CDM group and the second subset of DMRS ports corresponds to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein a largest respective port number of the first subset of respective port numbers is smaller than a smallest respective port number of the second subset of respective port numbers based at least in part on at least one of a determination that the first number of DMRS ports is not equal to the first number of transmission layers, or a determination that the second number of DMRS ports is not equal to the second number of transmission layers.

In a fourteenth aspect, alone or in combination with one or more of the first through fifth aspects, process 500 includes receiving a DCI transmission, wherein the DCI transmission includes a dynamic switching field that indicates a reversed order, wherein, based at least in part on receiving the DCI transmission, the second subset of DMRS ports includes a first number of DMRS ports corresponding to a first subset of respective port numbers of the set of port numbers equal to the second number of transmission layers, wherein the first subset of DMRS ports includes a second number of DMRS ports corresponding to a second subset of respective port numbers of the set of port numbers equal to the first number of transmission layers, and wherein a largest respective port number of the second subset of respective port numbers is smaller than a smallest respective port number of the first subset of respective port numbers.

In a fifteenth aspect, alone or in combination with the fourteenth aspect, the first subset of DMRS ports corresponds to a first CDM group and the second subset of DMRS ports corresponds to a second CDM group, and the first number of transmission layers is different than the second number of transmission layers, and process 500 further includes receiving a DCI transmission, wherein the DCI transmission includes a dynamic switching field that indicates a reversed order.

In a sixteenth aspect, alone or in combination with one or more of the first through fifteenth aspects, process 500 includes determining an error based at least in part on the first subset of DMRS ports corresponding to a first CDM group and the second subset of DMRS ports corresponding to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein determining the error comprises determining that the first number of transmission layers is not equal to the second number of transmission layers.

In a seventeenth aspect, alone or in combination with one or more of the first through sixteenth aspects, process 500 includes determining an error based at least in part on the first subset of DMRS ports corresponding to a first CDM group and the second subset of DMRS ports corresponding to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein determining the error comprises at least one of determining that the first number of DMRS ports is not equal to the first number of transmission layers, or determining that the second number of DMRS ports is not equal to the second number of transmission layers.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 410) performs operations associated with associating DMRS ports to SRS resource sets for SDM communications.

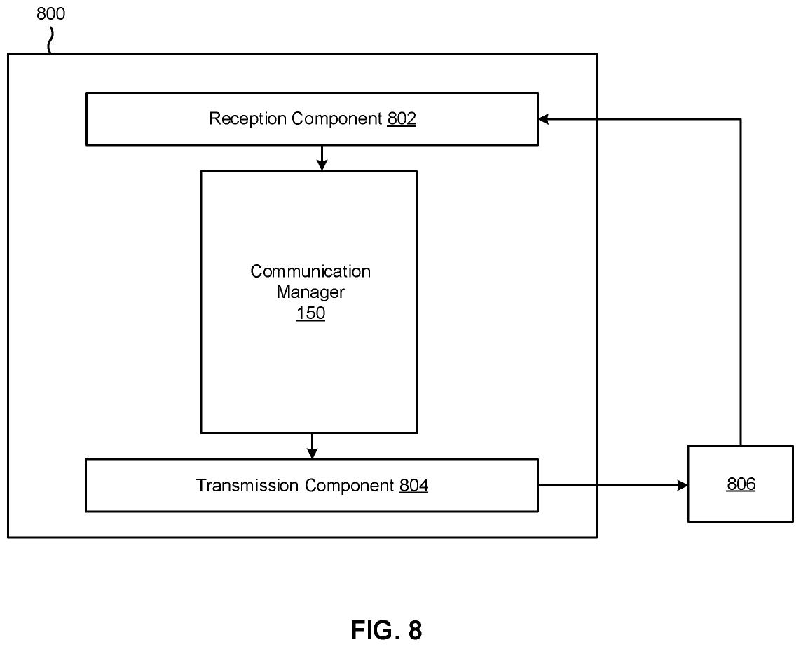

As shown in FIG. 6, in some aspects, process 600 may include transmitting a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers (block 610). For example, the base station (e.g., using communication manager 150 and/or transmission component 804, depicted in FIG. 8) may transmit a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers, as described above.

As further shown in FIG. 6, in some aspects, process 600 may include receiving a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers (block 620). For example, the base station (e.g., using communication manager 150 and/or reception component 802, depicted in FIG. 8) may receive a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers, as described above.

Process 600 may include additional aspects, such as any single aspect or any combination of aspects described below and/or in connection with one or more other processes described elsewhere herein.

In a first aspect, the first subset of DMRS ports comprises a first number of DMRS ports and the second subset of DMRS ports comprises a second number of DMRS ports.

In a second aspect, alone or in combination with the first aspect, receiving the PUSCH communication comprises receiving the first set of transmission layers and the second set of transmission layers using non-codebook-based transmission, wherein the first number of DMRS ports is based at least in part on a first number of SRS resources in the first SRS resource set, and wherein the second number of DMRS ports is based at least in part on a second number of SRS resources in the second SRS resource set.

In a third aspect, alone or in combination with the second aspect, process 600 includes transmitting a DCI transmission comprising a first SRI field that indicates the first number of SRS resources and a second SRI field that indicates the second number of SRS resources.

In a fourth aspect, alone or in combination with one or more of the first through third aspects, receiving the PUSCH communication comprises receiving the first set of transmission layers and the second set of transmission layers using codebook-based transmission, wherein the first number of DMRS ports is based at least in part on a first number of transmission layers associated with a first TPMI, and wherein the second number of DMRS ports is based at least in part on a second number of transmission layers associated with a second TPMI.

In a fifth aspect, alone or in combination with the fourth aspect, process 600 includes transmitting a downlink control information transmission comprising a first TPMI field that indicates the first number of transmission layers and a second TPMI field that indicates the second number of transmission layers.

In a sixth aspect, alone or in combination with one or more of the first through fifth aspects, the first subset of DMRS ports includes a first number of DMRS ports, corresponding to a first subset of respective port numbers of the set of port numbers, equal to the first number of transmission layers, and the second subset of DMRS ports includes a second number of DMRS ports, corresponding to a second subset of respective port numbers of the set of port numbers, equal to the second number of transmission layers, wherein a largest respective port number of the first subset of respective port numbers is smaller than a smallest respective port number of the second subset of respective port numbers.

In a seventh aspect, alone or in combination with the sixth aspect, process 600 includes transmitting a DCI transmission, wherein the DCI transmission does not include a dynamic switching field.

In an eighth aspect, alone or in combination with the sixth aspect, process 600 includes transmitting a DCI transmission, wherein the DCI transmission indicates no reversed order.

In a ninth aspect, alone or in combination with one or more of the fifth through eighth aspects, each DMRS port of the set of DMRS ports corresponds to a single code division multiplexing group.

In a tenth aspect, alone or in combination with one or more of the fifth through eighth aspects, the first subset of DMRS ports corresponds to a first CDM group and the second subset of DMRS ports corresponds to a second CDM group.

In an eleventh aspect, alone or in combination with one or more of the fifth through tenth aspects, the first number of transmission layers equals the second number of transmission layers.

In a twelfth aspect, alone or in combination with the fifth aspect, the first subset of DMRS ports corresponds to a first CDM group and the second subset of DMRS ports corresponds to a second CDM group, and the first number of transmission layers is different than the second number of transmission layers, and process 600 further includes transmitting a DCI transmission, wherein the DCI transmission includes a dynamic switching field that indicates a reversed order.

In a thirteenth aspect, alone or in combination with one or more of the first through twelfth aspects, the first subset of DMRS ports corresponds to a first CDM group and the second subset of DMRS ports corresponds to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein a largest respective port number of the first subset of respective port numbers is smaller than a smallest respective port number of the second subset of respective port numbers based at least in part on at least one of a determination that the first number of DMRS ports is not equal to the first number of transmission layers, or a determination that the second number of DMRS ports is not equal to the second number of transmission layers.

In a fourteenth aspect, alone or in combination with one or more of the first through thirteenth aspects, process 600 includes transmitting a DCI transmission, wherein the DCI transmission includes a dynamic switching field that indicates a reversed order, wherein, based at least in part on transmitting the DCI transmission, the second subset of DMRS ports includes a first number of DMRS ports corresponding to a first subset of respective port numbers of the set of port numbers equal to the second number of transmission layers, wherein the first subset of DMRS ports includes a second number of DMRS ports corresponding to a second subset of respective port numbers of the set of port numbers equal to the first number of transmission layers, and wherein a largest respective port number of the second subset of respective port numbers is smaller than a smallest respective port number of the first subset of respective port numbers.

In a fifteenth aspect, alone or in combination with the fourteenth aspect, the first subset of DMRS ports corresponds to a first CDM group and the second subset of DMRS ports corresponds to a second CDM group, and the first number of transmission layers is different than the second number of transmission layers, and process 600 further includes transmitting a DCI transmission, wherein the DCI transmission includes a dynamic switching field that indicates a reversed order.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include a determination component 708.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers. The transmission component 704 may transmit a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

The reception component 702 may receive a DCI transmission comprising a first SRI field that indicates the first number of SRS resources and a second SRI field that indicates the second number of SRS resources.

The reception component 702 may receive a DCI transmission comprising a first TPMI field that indicates the first number of transmission layers and a second TPMI field that indicates the second number of transmission layers. The reception component 702 may receive a DCI transmission, wherein the DCI transmission does not include a dynamic switching field. The reception component 702 may receive a DCI transmission, wherein the DCI transmission indicates no reversed order.

The reception component 702 may receive a DCI transmission, wherein the DCI transmission includes a dynamic switching field that indicates a reversed order, wherein, based at least in part on receiving the DCI transmission, the second subset of DMRS ports includes a first number of DMRS ports corresponding to a first subset of respective port numbers of the set of port numbers equal to the second number of transmission layers, wherein the first subset of DMRS ports includes a second number of DMRS ports corresponding to a second subset of respective port numbers of the set of port numbers equal to the first number of transmission layers, and wherein a largest respective port number of the second subset of respective port numbers is smaller than a smallest respective port number of the first subset of respective port numbers.

The communication manager 140 and/or determination component 708 may determine an error based at least in part on the first subset of DMRS ports corresponding to a first CDM group and the second subset of DMRS ports corresponding to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein determining the error comprises determining that the first number of transmission layers is not equal to the second number of transmission layers.

In some aspects, the communication manager 140 may include one or more antennas, a modem, a modulator, a controller/processor, a memory, or a combination thereof, of the UE described in connection with FIG. 2. In some aspects, the communication manager 140 may include the reception component 702 and/or the transmission component 704. In some aspects, the determination component 708 may include one or more antennas, a modem, a modulator, a controller/processor, a memory, or a combination thereof, of the UE described in connection with FIG. 2. In some aspects, the determination component 708 may include the reception component 702 and/or the transmission component 704.

The determination component 708 may determine an error based at least in part on the first subset of DMRS ports corresponding to a first CDM group and the second subset of DMRS ports corresponding to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein determining the error comprises at least one of determining that the first number of DMRS ports is not equal to the first number of transmission layers, or determining that the second number of DMRS ports is not equal to the second number of transmission layers.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The transmission component 804 may transmit a spatial division multiplexing configuration associated with a PUSCH having a first set of transmission layers corresponding to a first SRS resource set and a second set of transmission layers corresponding to a second SRS resource set, wherein the first set of transmission layers comprises a first number of transmission layers and the second set of transmission layers comprises a second number of transmission layers. The reception component 802 may receive a PUSCH communication that includes the first set of transmission layers and the second set of transmission layers based at least in part on a port mapping that indicates a first association between a first subset of DMRS ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

The transmission component 804 may transmit a DCI transmission comprising a first SRI field that indicates the first number of SRS resources and a second SRI field that indicates the second number of SRS resources.

The transmission component 804 may transmit a DCI transmission comprising a first TPMI field that indicates the first number of transmission layers and a second TPMI field that indicates the second number of transmission layers. The transmission component 804 may transmit a DCI transmission, wherein the DCI transmission does not include a dynamic switching field. The transmission component 804 may transmit a DCI transmission, wherein the DCI transmission indicates no reversed order.

The transmission component 804 may transmit a DCI transmission, wherein the DCI transmission includes a dynamic switching field that indicates a reversed order, wherein, based at least in part on transmitting the DCI transmission, the second subset of DMRS ports includes a first number of DMRS ports corresponding to a first subset of respective port numbers of the set of port numbers equal to the second number of transmission layers, wherein the first subset of DMRS ports includes a second number of DMRS ports corresponding to a second subset of respective port numbers of the set of port numbers equal to the first number of transmission layers, and wherein a largest respective port number of the second subset of respective port numbers is smaller than a smallest respective port number of the first subset of respective port numbers.

In some aspects, the communication manager 150 may control and/or manage one or more aspects of operations performed by the reception component 802 and/or the transmission component 804. In some aspects, the communication manager 150 may include one or more antennas, a modem, a modulator, a controller/processor, a memory, or a combination thereof, of the base station described in connection with FIG. 2. In some aspects, the communication manager 150 may include the reception component 802 and/or the transmission component 804.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The Following Provides an Overview of Some Aspects of the Present Disclosure:

Aspect 1: A method of wireless communication performed by a user equipment (UE), comprising: receiving a spatial division multiplexing configuration associated with a physical uplink shared channel (PUSCH) having a first set of transmission layers corresponding to a first sounding reference signal (SRS) resource set and a second set of transmission layers corresponding to a second SRS resource set, wherein the first set of transmission layers comprises a first number of transmission layers and the second set of transmission layers comprises a second number of transmission layers; and transmitting a PUSCH communication that includes the first set of transmission layers and the second set of transmission layers based at least in part on a port mapping that indicates a first association between a first subset of demodulation reference signal (DMRS) ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Aspect 2: The method of Aspect 1, wherein the first subset of DMRS ports comprises a first number of DMRS ports and wherein the second subset of DMRS ports comprises a second number of DMRS ports.

Aspect 3: The method of Aspect 2, wherein transmitting the PUSCH communication comprises transmitting the first set of transmission layers and the second set of transmission layers using non-codebook-based transmission, wherein the first number of DMRS ports is based at least in part on a first number of SRS resources in the first SRS resource set, and wherein the second number of DMRS ports is based at least in part on a second number of SRS resources in the second SRS resource set.

Aspect 4: The method of Aspect 3, further comprising receiving a downlink control information (DCI) transmission comprising a first SRS resource indicator (SRI) field that indicates the first number of SRS resources and a second SRI field that indicates the second number of SRS resources.

Aspect 5: The method of any of Aspects 2-4, wherein transmitting the PUSCH communication comprises transmitting the first set of transmission layers and the second set of transmission layers using codebook-based transmission, wherein the first number of DMRS ports is based at least in part on a first number of transmission layers associated with a first transmitted precoding matrix indicator (TPMI), and wherein the second number of DMRS ports is based at least in part on a second number of transmission layers associated with a second TPMI.

Aspect 6: The method of Aspect 5, further comprising receiving a downlink control information transmission comprising a first TPMI field that indicates the first number of transmission layers and a second TPMI field that indicates the second number of transmission layers.

Aspect 7: The method of any of Aspects 1-6, wherein the first subset of DMRS ports includes a first number of DMRS ports, corresponding to a first subset of respective port numbers of the set of port numbers, equal to the first number of transmission layers, and wherein the second subset of DMRS ports includes a second number of DMRS ports, corresponding to a second subset of respective port numbers of the set of port numbers, equal to the second number of transmission layers, wherein a largest respective port number of the first subset of respective port numbers is smaller than a smallest respective port number of the second subset of respective port numbers.

Aspect 8: The method of Aspect 7, further comprising receiving a downlink control information (DCI) transmission, wherein the DCI transmission does not include a dynamic switching field.

Aspect 9: The method of Aspect 7, further comprising receiving a downlink control information (DCI) transmission, wherein the DCI transmission indicates no reversed order.

Aspect 10: The method of any of Aspects 7-9, wherein each DMRS port of the set of DMRS ports corresponds to a single code division multiplexing group.

Aspect 11: The method of any of Aspects 7-9, wherein the first subset of DMRS ports corresponds to a first code division multiplexing (CDM) group and the second subset of DMRS ports corresponds to a second CDM group.

Aspect 12: The method of any of Aspects 7-11, wherein the first number of transmission layers equals the second number of transmission layers.

Aspect 13: The method of Aspect 7, wherein the first subset of DMRS ports corresponds to a first code division multiplexing (CDM) group and the second subset of DMRS ports corresponds to a second CDM group, and wherein the first number of transmission layers is different than the second number of transmission layers, the method further comprising receiving a downlink control information (DCI) transmission, wherein the DCI transmission includes a dynamic switching field that indicates a reversed order.

Aspect 14: The method of any of Aspects 1-6, wherein the first subset of DMRS ports corresponds to a first code division multiplexing (CDM) group and the second subset of DMRS ports corresponds to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein a largest respective port number of the first subset of respective port numbers is smaller than a smallest respective port number of the second subset of respective port numbers based at least in part on at least one of: a determination that the first number of DMRS ports is not equal to the first number of transmission layers, or a determination that the second number of DMRS ports is not equal to the second number of transmission layers.

Aspect 15: The method of any of Aspects 1-6, further comprising receiving a downlink control information (DCI) transmission, wherein the DCI transmission includes a dynamic switching field that indicates a reversed order, wherein, based at least in part on receiving the DCI transmission, the second subset of DMRS ports includes a first number of DMRS ports corresponding to a first subset of respective port numbers of the set of port numbers equal to the second number of transmission layers, wherein the first subset of DMRS ports includes a second number of DMRS ports corresponding to a second subset of respective port numbers of the set of port numbers equal to the first number of transmission layers, and wherein a largest respective port number of the second subset of respective port numbers is smaller than a smallest respective port number of the first subset of respective port numbers.

Aspect 16: The method of Aspect 15, wherein the first subset of DMRS ports corresponds to a first code division multiplexing (CDM) group and the second subset of DMRS ports corresponds to a second CDM group, and wherein the first number of transmission layers is different than the second number of transmission layers, the method further comprising receiving a downlink control information (DCI) transmission, wherein the DCI transmission includes a dynamic switching field that indicates a reversed order.

Aspect 17: The method of any of Aspects 1-16, further comprising determining an error based at least in part on the first subset of DMRS ports corresponding to a first code division multiplexing (CDM) group and the second subset of DMRS ports corresponding to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein determining the error comprises: determining that the first number of transmission layers is not equal to the second number of transmission layers.

Aspect 18: The method of any of Aspects 1-17, further comprising determining an error based at least in part on the first subset of DMRS ports corresponding to a first code division multiplexing (CDM) group and the second subset of DMRS ports corresponding to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein determining the error comprises at least one of: determining that the first number of DMRS ports is not equal to the first number of transmission layers, or determining that the second number of DMRS ports is not equal to the second number of transmission layers.

Aspect 19: A method of wireless communication performed by a base station, comprising: transmitting a spatial division multiplexing configuration associated with a physical uplink shared channel (PUSCH) having a first set of transmission layers corresponding to a first sounding reference signal (SRS) resource set and a second set of transmission layers corresponding to a second SRS resource set, wherein the first set of transmission layers comprises a first number of transmission layers and the second set of transmission layers comprises a second number of transmission layers; and receiving a PUSCH communication that includes the first set of transmission layers and the second set of transmission layers based at least in part on a port mapping that indicates a first association between a first subset of demodulation reference signal (DMRS) ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

Aspect 20: The method of Aspect 19, wherein the first subset of DMRS ports comprises a first number of DMRS ports and wherein the second subset of DMRS ports comprises a second number of DMRS ports.

Aspect 21: The method of Aspect 20, wherein receiving the PUSCH communication comprises receiving the first set of transmission layers and the second set of transmission layers using non-codebook-based transmission, wherein the first number of DMRS ports is based at least in part on a first number of SRS resources in the first SRS resource set, and wherein the second number of DMRS ports is based at least in part on a second number of SRS resources in the second SRS resource set.

Aspect 22: The method of Aspect 21, further comprising transmitting a downlink control information (DCI) transmission comprising a first SRS resource indicator (SRI) field that indicates the first number of SRS resources and a second SRI field that indicates the second number of SRS resources.

Aspect 23: The method of any of Aspects 20-22, wherein receiving the PUSCH communication comprises receiving the first set of transmission layers and the second set of transmission layers using codebook-based transmission, wherein the first number of DMRS ports is based at least in part on a first number of transmission layers associated with a first transmitted precoding matrix indicator (TPMI), and wherein the second number of DMRS ports is based at least in part on a second number of transmission layers associated with a second TPMI.

Aspect 24: The method of Aspect 23, further comprising transmitting a downlink control information transmission comprising a first TPMI field that indicates the first number of transmission layers and a second TPMI field that indicates the second number of transmission layers.

Aspect 25: The method of any of Aspects 19-24, wherein the first subset of DMRS ports includes a first number of DMRS ports, corresponding to a first subset of respective port numbers of the set of port numbers, equal to the first number of transmission layers, and wherein the second subset of DMRS ports includes a second number of DMRS ports, corresponding to a second subset of respective port numbers of the set of port numbers, equal to the second number of transmission layers, wherein a largest respective port number of the first subset of respective port numbers is smaller than a smallest respective port number of the second subset of respective port numbers.

Aspect 26: The method of Aspect 25, further comprising transmitting a downlink control information (DCI) transmission, wherein the DCI transmission does not include a dynamic switching field.

Aspect 27: The method of Aspect 25, further comprising transmitting a downlink control information (DCI) transmission, wherein the DCI transmission indicates no reversed order.

Aspect 28: The method of any of Aspects 25-27, wherein each DMRS port of the set of DMRS ports corresponds to a single code division multiplexing group.

Aspect 29: The method of any of Aspects 25-27, wherein the first subset of DMRS ports corresponds to a first code division multiplexing (CDM) group and the second subset of DMRS ports corresponds to a second CDM group.

Aspect 30: The method of any of Aspects 25-29, wherein the first number of transmission layers equals the second number of transmission layers.

Aspect 31: The method of Aspect 25, wherein the first subset of DMRS ports corresponds to a first code division multiplexing (CDM) group and the second subset of DMRS ports corresponds to a second CDM group, and wherein the first number of transmission layers is different than the second number of transmission layers, the method further comprising transmitting a downlink control information (DCI) transmission, wherein the DCI transmission includes a dynamic switching field that indicates a reversed order.

Aspect 32: The method of any of Aspects 19-24, wherein the first subset of DMRS ports corresponds to a first code division multiplexing (CDM) group and the second subset of DMRS ports corresponds to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein a largest respective port number of the first subset of respective port numbers is smaller than a smallest respective port number of the second subset of respective port numbers based at least in part on at least one of: a determination that the first number of DMRS ports is not equal to the first number of transmission layers, or a determination that the second number of DMRS ports is not equal to the second number of transmission layers.

Aspect 33: The method of any of Aspects 19-24, further comprising transmitting a downlink control information (DCI) transmission, wherein the DCI transmission includes a dynamic switching field that indicates a reversed order, wherein, based at least in part on transmitting the DCI transmission, the second subset of DMRS ports includes a first number of DMRS ports corresponding to a first subset of respective port numbers of the set of port numbers equal to the second number of transmission layers, wherein the first subset of DMRS ports includes a second number of DMRS ports corresponding to a second subset of respective port numbers of the set of port numbers equal to the first number of transmission layers, and wherein a largest respective port number of the second subset of respective port numbers is smaller than a smallest respective port number of the first subset of respective port numbers.

Aspect 34: The method of Aspect 33, wherein the first subset of DMRS ports corresponds to a first code division multiplexing (CDM) group and the second subset of DMRS ports corresponds to a second CDM group, and wherein the first number of transmission layers is different than the second number of transmission layers, the method further comprising transmitting a downlink control information (DCI) transmission, wherein the DCI transmission includes a dynamic switching field that indicates a reversed order.

Aspect 35: An apparatus for wireless communication at a device, comprising a processor; memory coupled with the processor; and instructions stored in the memory and executable by the processor to cause the apparatus to perform the method of one or more of Aspects 1-18.

Aspect 36: A device for wireless communication, comprising a memory and one or more processors coupled to the memory, the one or more processors configured to perform the method of one or more of Aspects 1-18.

Aspect 37: An apparatus for wireless communication, comprising at least one means for performing the method of one or more of Aspects 1-18.

Aspect 38: A non-transitory computer-readable medium storing code for wireless communication, the code comprising instructions executable by a processor to perform the method of one or more of Aspects 1-18.

Aspect 39: A non-transitory computer-readable medium storing a set of instructions for wireless communication, the set of instructions comprising one or more instructions that, when executed by one or more processors of a device, cause the device to perform the method of one or more of Aspects 1-18.

Aspect 40: An apparatus for wireless communication at a device, comprising a processor; memory coupled with the processor; and instructions stored in the memory and executable by the processor to cause the apparatus to perform the method of one or more of Aspects 19-34.

Aspect 41: A device for wireless communication, comprising a memory and one or more processors coupled to the memory, the one or more processors configured to perform the method of one or more of Aspects 19-34.

Aspect 42: An apparatus for wireless communication, comprising at least one means for performing the method of one or more of Aspects 19-34.

Aspect 43: A non-transitory computer-readable medium storing code for wireless communication, the code comprising instructions executable by a processor to perform the method of one or more of Aspects 19-34.

Aspect 44: A non-transitory computer-readable medium storing a set of instructions for wireless communication, the set of instructions comprising one or more instructions that, when executed by one or more processors of a device, cause the device to perform the method of one or more of Aspects 19-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a spatial division multiplexing configuration associated with a physical uplink shared channel (PUSCH) having a first set of transmission layers corresponding to a first sounding reference signal (SRS) resource set and a second set of transmission layers corresponding to a second SRS resource set, wherein the first set of transmission layers comprises a first number of transmission layers and the second set of transmission layers comprises a second number of transmission layers; and
transmit a PUSCH communication that includes the first set of transmission layers and the second set of transmission layers based at least in part on a port mapping that indicates a first association between a first subset of demodulation reference signal (DMRS) ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

2. The UE of claim 1, wherein the first subset of DMRS ports comprises a first number of DMRS ports and wherein the second subset of DMRS ports comprises a second number of DMRS ports.

3. The UE of claim 2, wherein the one or more processors, to transmit the PUSCH communication, are configured to transmit the first set of transmission layers and the second set of transmission layers using non-codebook-based transmission, wherein the first number of DMRS ports is based at least in part on a first number of SRS resources in the first SRS resource set, and wherein the second number of DMRS ports is based at least in part on a second number of SRS resources in the second SRS resource set.

4. The UE of claim 3, wherein the one or more processors are further configured to receive a downlink control information (DCI) transmission comprising a first SRS resource indicator (SRI) field that indicates the first number of SRS resources and a second SRI field that indicates the second number of SRS resources.

5. The UE of claim 2, wherein the one or more processors, to transmit the PUSCH communication, are configured to transmit the first set of transmission layers and the second set of transmission layers using codebook-based transmission, wherein the first number of DMRS ports is based at least in part on a first number of transmission layers associated with a first transmitted precoding matrix indicator (TPMI), and wherein the second number of DMRS ports is based at least in part on a second number of transmission layers associated with a second TPMI.

6. The UE of claim 5, wherein the one or more processors are further configured to receive a downlink control information transmission comprising a first TPMI field that indicates the first number of transmission layers and a second TPMI field that indicates the second number of transmission layers.

7. The UE of claim 1, wherein the first subset of DMRS ports includes a first number of DMRS ports, corresponding to a first subset of respective port numbers of the set of port numbers, equal to the first number of transmission layers, and wherein the second subset of DMRS ports includes a second number of DMRS ports, corresponding to a second subset of respective port numbers of the set of port numbers, equal to the second number of transmission layers, wherein a largest respective port number of the first subset of respective port numbers is smaller than a smallest respective port number of the second subset of respective port numbers.

8. The UE of claim 7, wherein the one or more processors are further configured to receive a downlink control information (DCI) transmission, wherein the DCI transmission does not include a dynamic switching field.

9. The UE of claim 7, wherein the one or more processors are further configured to receive a downlink control information (DCI) transmission, wherein the DCI transmission indicates no reversed order.

10. The UE of claim 7, wherein each DMRS port of the set of DMRS ports corresponds to a single code division multiplexing group.

11. The UE of claim 7, wherein the first subset of DMRS ports corresponds to a first code division multiplexing (CDM) group and the second subset of DMRS ports corresponds to a second CDM group.

12. The UE of claim 7, wherein the first number of transmission layers equals the second number of transmission layers.

13. The UE of claim 7, wherein the first subset of DMRS ports corresponds to a first code division multiplexing (CDM) group and the second subset of DMRS ports corresponds to a second CDM group, wherein the first number of transmission layers is different than the second number of transmission layers, and wherein the one or more processors are further configured to receive a downlink control information (DCI) transmission, wherein the DCI transmission includes a dynamic switching field that indicates a reversed order.

14. The UE of claim 1, wherein the first subset of DMRS ports corresponds to a first code division multiplexing (CDM) group and the second subset of DMRS ports corresponds to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein a largest respective port number of the first subset of respective port numbers is smaller than a smallest respective port number of the second subset of respective port numbers based at least in part on at least one of:
a determination that the first number of DMRS ports is not equal to the first number of transmission layers, or
a determination that the second number of DMRS ports is not equal to the second number of transmission layers.

15. The UE of claim 1, wherein the one or more processors are further configured to receive a downlink control information (DCI) transmission, wherein the DCI transmission includes a dynamic switching field that indicates a reversed order, wherein, based at least in part on receiving the DCI transmission, the second subset of DMRS ports includes a first number of DMRS ports corresponding to a first subset of respective port numbers of the set of port numbers equal to the second number of transmission layers, wherein the first subset of DMRS ports includes a second number of DMRS ports corresponding to a second subset of respective port numbers of the set of port numbers equal to the first number of transmission layers, and wherein a largest respective port number of the second subset of respective port numbers is smaller than a smallest respective port number of the first subset of respective port numbers.

16. The UE of claim 15, wherein the first subset of DMRS ports corresponds to a first code division multiplexing (CDM) group and the second subset of DMRS ports corresponds to a second CDM group, wherein the first number of transmission layers is different than the second number of transmission layers, and wherein the one or more processors are further configured to receive a downlink control information (DCI) transmission, wherein the DCI transmission includes a dynamic switching field that indicates a reversed order.

17. The UE of claim 1, wherein the one or more processors are further configured to determine an error based at least in part on the first subset of DMRS ports corresponding to a first code division multiplexing (CDM) group and the second subset of DMRS ports corresponding to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein the one or more processors, to determine the error, are configured to:
determine that the first number of transmission layers is not equal to the second number of transmission layers.

18. The UE of claim 1, wherein the one or more processors are further configured to determine an error based at least in part on the first subset of DMRS ports corresponding to a first code division multiplexing (CDM) group and the second subset of DMRS ports corresponding to a second CDM group, wherein the first subset of DMRS ports includes a first number of DMRS ports corresponding to a first subset of respective port numbers of the set of port numbers, wherein the second subset of DMRS ports includes a second number of DMRS ports corresponding to a second subset of respective port numbers of the set of port numbers, and wherein the one or more processors, to determine the error, are configured to perform at least one of:
a determination that the first number of DMRS ports is not equal to the first number of transmission layers, or
a determination that the second number of DMRS ports is not equal to the second number of transmission layers.

19. A base station for wireless communication, comprising:
a memory; and
one or more processors, coupled to the memory, configured to:
transmit a spatial division multiplexing configuration associated with a physical uplink shared channel (PUSCH) having a first set of transmission layers corresponding to a first sounding reference signal (SRS) resource set and a second set of transmission layers corresponding to a second SRS resource set, wherein the first set of transmission layers comprises a first number of transmission layers and the second set of transmission layers comprises a second number of transmission layers; and
receive a PUSCH communication that includes the first set of transmission layers and the second set of transmission layers based at least in part on a port mapping that indicates a first association between a first subset of demodulation reference signal (DMRS) ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

20. The base station of claim 19, wherein the first subset of DMRS ports comprises a first number of DMRS ports and wherein the second subset of DMRS ports comprises a second number of DMRS ports.

21. The base station of claim 20, wherein the one or more processors, to receive the PUSCH communication, are configured to receive the first set of transmission layers and the second set of transmission layers using non-codebook-based transmission, wherein the first number of DMRS ports is based at least in part on a first number of SRS resources in the first SRS resource set, and wherein the second number of DMRS ports is based at least in part on a second number of SRS resources in the second SRS resource set.

22. The base station of claim 21, wherein the one or more processors are further configured to transmit a downlink control information (DCI) transmission comprising a first SRS resource indicator (SRI) field that indicates the first number of SRS resources and a second SRI field that indicates the second number of SRS resources.

23. The base station of claim 20, wherein the one or more processors, to receive the PUSCH communication, are configured to receive the first set of transmission layers and the second set of transmission layers using codebook-based transmission, wherein the first number of DMRS ports is based at least in part on a first number of transmission layers associated with a first transmitted precoding matrix indicator (TPMI), and wherein the second number of DMRS ports is based at least in part on a second number of transmission layers associated with a second TPMI.

24. The base station of claim 23, wherein the one or more processors are further configured to transmit a downlink control information transmission comprising a first TPMI field that indicates the first number of transmission layers and a second TPMI field that indicates the second number of transmission layers.

25. The base station of claim 19, wherein the first subset of DMRS ports includes a first number of DMRS ports, corresponding to a first subset of respective port numbers of the set of port numbers, equal to the first number of transmission layers, and wherein the second subset of DMRS ports includes a second number of DMRS ports, corresponding to a second subset of respective port numbers of the set of port numbers, equal to the second number of transmission layers, wherein a largest respective port number of the first subset of respective port numbers is smaller than a smallest respective port number of the second subset of respective port numbers.

26. The base station of claim 25, wherein the one or more processors are further configured to transmit a downlink control information (DCI) transmission, wherein the DCI transmission does not include a dynamic switching field.

27. A method of wireless communication performed by a user equipment (UE), comprising:
receiving a spatial division multiplexing configuration associated with a physical uplink shared channel (PUSCH) having a first set of transmission layers corresponding to a first sounding reference signal (SRS) resource set and a second set of transmission layers corresponding to a second SRS resource set, wherein the first set of transmission layers comprises a first number of transmission layers and the second set of transmission layers comprises a second number of transmission layers; and
transmitting a PUSCH communication that includes the first set of transmission layers and the second set of transmission layers based at least in part on a port mapping that indicates a first association between a first subset of demodulation reference signal (DMRS) ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

28. The method of claim 27, wherein the first subset of DMRS ports comprises a first number of DMRS ports and wherein the second subset of DMRS ports comprises a second number of DMRS ports.

29. A method of wireless communication performed by a base station, comprising:
transmitting a spatial division multiplexing configuration associated with a physical uplink shared channel (PUSCH) having a first set of transmission layers corresponding to a first sounding reference signal (SRS) resource set and a second set of transmission layers corresponding to a second SRS resource set, wherein the first set of transmission layers comprises a first number of transmission layers and the second set of transmission layers comprises a second number of transmission layers; and
receiving a PUSCH communication that includes the first set of transmission layers and the second set of transmission layers based at least in part on a port mapping that indicates a first association between a first subset of demodulation reference signal (DMRS) ports of a set of DMRS ports and the first set of transmission layers, and a second association between a second subset of DMRS ports of the set of DMRS ports and the second set of transmission layers, wherein each DMRS port in the set of DMRS ports has a different respective port number of a set of port numbers.

30. The method of claim 29, wherein the first subset of DMRS ports comprises a first number of DMRS ports and wherein the second subset of DMRS ports comprises a second number of DMRS ports.
